(19) United States
(12) Patent Application Publication
(10) Pub. No.: US 2014/0103561 A1
(43) Pub. Date: Apr. 17, 2014

(54) METHOD FOR MOLDING COMPOSITE MATERIAL

(71) Applicant: JIIN-BIAU HUANG, TAIPEI CITY (TW)

(72) Inventor: JIIN-BIAU HUANG, TAIPEI CITY (TW)

(21) Appl. No.: 14/053,753

(22) Filed: Oct. 15, 2013

(30) Foreign Application Priority Data
Oct. 15, 2012 (TW) 101137991

(51) Int. Cl. B29C 44/18

(52) U.S. Cl. CPC B29C 44/18
USPC 264/46.6

(57) ABSTRACT

A method for molding composite material is revealed. A hollow air bag with high toughness is made from elastic material by a first mold, and then injects a filler such as foaming material or filling material into the air bag to form core material that connects to the air bag. The air bag with the core material matches the size and shape of the mold where the air bag with the core material has a feature of smooth surface so that it is covered with composite material such as fiber fabric easily. Next, the air bag with the core material covered by the composite material is set into a third mold to be inflated and heated. Thus a composite material product that matches the size of the mold is obtained wherein the air bag and the core material are released easily. The method simplifies the procedures and saves energy.

### FIELD OF THE INVENTION

The present invention relates to a method for molding composite material, especially to a method for molding composite material that uses molds, elastic material with high toughness, and foaming material through different stages.

### BACKGROUND OF THE INVENTION

A composite material available now is composed of reinforcement embedded in a matrix. The reinforcement improves the overall mechanical properties of products such as stiffness and strength. Materials with high stiffness in the form of particles, flakes, short fibers and continuous fibers are distributed in the matrix, wherein fibers are the most common reinforcement. Among fibers, continuous fibers provide better mechanical property such as high modulous. Although the fibers have quite high tensile strength and stiffness, it is unable to bear the axial compressive stress. Under the condition without protection, the surface of the fiber is easy to suffer from eroded by environmental chemicals and have surface defects. Thus without the matrix as coordination, fibers are unable to connect to other components and form the structure.

In the past, conventional production and processing procedures used in the composite material industry have many shortcomings. For example, the composite material laminate used is preformed to replace the core material. The method is labor and time consuming and there are some problems related to connection. In the industry, rubber, silicone and polyurethane foaming resin are usually used as raw materials for the inner core of the product. However, they can only be used in partially molded products and have to assemble or install through other components. There are problems in smoothness and strength, and negative results are seen.

Expanded polystyrene (EPS) with nylon tubes or air bags outside can be used to form core material as a whole profile. But it would be too light to use and there is difficulties in operation that a part of products produced are irregular-shaped with different sizes. If it chooses to do EPS coating such as dip painting, brush painting, spray painting or flow painting of latex, it has unavoidable problems due to uneven coating film and breakage caused by bubbles or pinholes generated. The products have inconsistent quality. Both scrap rate and unpredictable risk are increased.

Refer to Chinese Pat. App. No. CN 201010142051.X, a method for continuously forming irregular-shaped fibrous tube is revealed. The method uses expanded polystyrene (EPS) material to prepare a model body. The whole outside surface of the model body is wrapped with a layer of heat resistant synthetic latex by a latex-dipping wrapping process and at least one gas introducing opening is provided. Then a band typing process is carried out to tightly wrap a fibrous band around the surface of the latex layer and the latex layer with the fibrous band around is set into a simple bolt-locked mold for heating and performing a curing process. When the polystyrene is coated with the heat resistant latex layer, it's difficult to have bubble free on the surface being coated. The thickness of the heat resistant latex layer may be not even. Thus a problem of poor yield rate occurs in the following processing procedures.

### SUMMARY

Therefore it is a primary object of the present invention to provide a method for molding composite material as a whole profile by which a hollow air bag is produced at first. Then inject a filler into the hollow air bag to form core material. Later cover the air bag with composite material. By inflation and heating, a composite material product having good appearance and sturdiness is formed in the mold smoothly.

It is another object of the present invention to provide a method for molding composite material in which not only the procedures are easy to operate, but also the products obtained are of quite good quality. The method can also be applied to prepare products with irregular shapes.

It is a further object of the present invention to provide a method for molding composite material which has features of material-saving, high efficiency and light weight appropriately. Thus the composite material products are competitive on the bike market.

In order to achieve the above objects, a method for molding composite materials according to the present invention includes a plurality of steps. First inject an elastic material into a first mold. Rotate or shake the first mold or let the first mold set, to form a hollow air bag in the first mold. Then move the hollow air bag into a second mold. Later inject a filler into the hollow air bag until the hollow air bag is filled and the filler forms a core material in the hollow air bag. Next cover a composite material over a surface of the hollow air bag and then set the hollow air bag in a third mold. Inflate the hollow air bag to expand the air bag and push the composite material to attach to an inner wall of the third mold. At the same time, heat the third mold until the composite material cured. At last, remove the third mold, the core material, and the hollow air bag to get a molded composite material product. The composite material product obtained by the method of the present invention has better smooth surface both inner and outer sides as well as good strength and physical properties.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 shows a flow chart showing steps of an embodiment according to the present invention;

FIG. 2 shows a schematic drawing showing structure of a first mold of an embodiment according to the present invention;

FIG. 3 shows a schematic drawing showing structure of a hollow air bag of an embodiment according to the present invention;

FIG. 4A shows a schematic cross section of a hollow air bag in a cavity of a second mold being filled with filler of an embodiment according to the present invention;

FIG. 4B shows a schematic cross section of a hollow air bag being expanded by core material so as to attach to a cavity of a second mold of an embodiment according to the present invention;

FIG. 5A shows a schematic cross section of core material being heated and shrunk in a cavity of a third mold of an embodiment according to the present invention;

FIG. 5B shows a schematic cross section of a hollow air bag with composite material being pushed continuously by gas so as to attach a cavity of a third mold of an embodiment according to the present invention.

### DETAILED DESCRIPTION

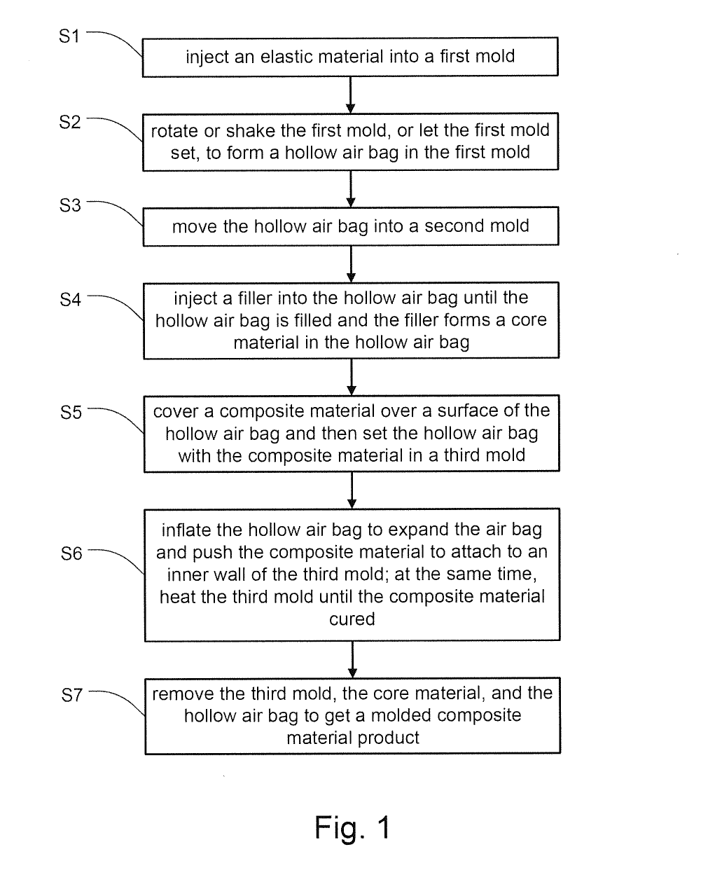

Refer to FIG. 1, a method for molding composite material according to the present invention includes a plurality of steps.

Step S1: inject an elastic material into a first mold;

Step S2: rotate or shake the first mold, or let the first mold set, to form a hollow air bag in the first mold;

Step S3: move the hollow air bag into a second mold;

Step S4: inject a filler into the hollow air bag until the hollow air bag is filled and the filler forms a core material in the hollow air bag;

Step S5: cover a composite material over a surface of the hollow air bag and then set the hollow air bag with the composite material in a third mold;

Step S6: inflate the hollow air bag to expand the air bag and push the composite material to attach to an inner wall of the third mold; at the same time, heat the third mold until the composite material cured; and

Step S7: remove the third mold, the core material, and the hollow air bag to get a molded composite material product.

Regarding above mentioned steps, the first mold, the second mold and the third mold are molds for casting produced according to 3-dimensional (3D) figures of the designed product. The materials for molds include metals, resin, gypsum and their mixtures. As to the size of the molds, the first mold is a bit less than or equal to the second mold while the second mold is a bit less than the third mold. These differences in the size are due to different requirements of the product such as structure design, physical properties, mechanical strength, etc.

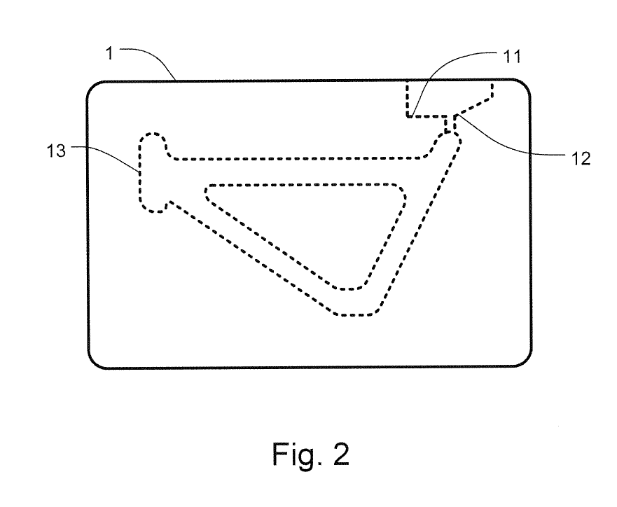

Refer to FIG. 2, a schematic drawing showing structure of the first mold 1 is revealed. The first mold 1 includes a pouring basin 11 and a gate 12 that allow the liquid being injected entering therein and a cavity 13 whose structure is designed according to the 3D figures mentioned above.

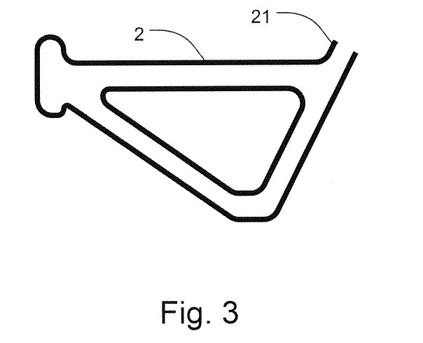

In the present invention, first run the step 1, inject the liquid elastic material into the first mold 1. The elastic material can fill the whole cavity 13 of the first mold 1 or only a part volume of the cavity 13. Then refer to the step 2, the first mold 1 is treated by different ways such as rotation, shaking or setting up according to types of the first mold 1 so as to make the elastic material attach to a surface of the cavity 13 and form a hollow air bag 2 shown in FIG. 3.

The elastic material is selected from the group consisting of silicone rubber, polyurethane resin, and emulsified rubber. The emulsified rubber can be natural or synthetic. After the elastic material being injected into the first mold 1, treated by various procedures such as rotation, shaking or static setting and heating, the hollow air bag 2 is formed by the cured elastic material. The thickness of the hollow air bag 2 is ranging from 0.1 mm to 30 mm and is determined according to the strength of the hollow air bag 2 the manufacturing processes required. The thickness is adjusted by changing the amount of the elastic material added. Moreover, the thickness can also be changed due to the shapes required. The hollow air bag 2 includes at least one nozzle 21 according to the original design.

Then the hollow air bag 2 is moved to a second mold 3. The diameter of the cavity of the second mold 3 is a bit larger or equal to the first mold 1. After the hollow air bag 2 being set into the second mold 3 by an operator, a certain amount of filler is filled into the hollow air bag 2 through the nozzle 21. The filler can be expanded/foaming material, polymer with high crystallinity, or their mixtures with low-density materials. The expanded/foaming material can be polyurethane (PU), resin with foam powder, resin with expanding powder, expanded polystyrene, etc. The polymer with high crystallinity includes polyvinyl alcohol (PVA), wax, etc. The mixtures with low-density materials are used to reduce total weight of the hollow air bag 2 being filled for convenient processing.

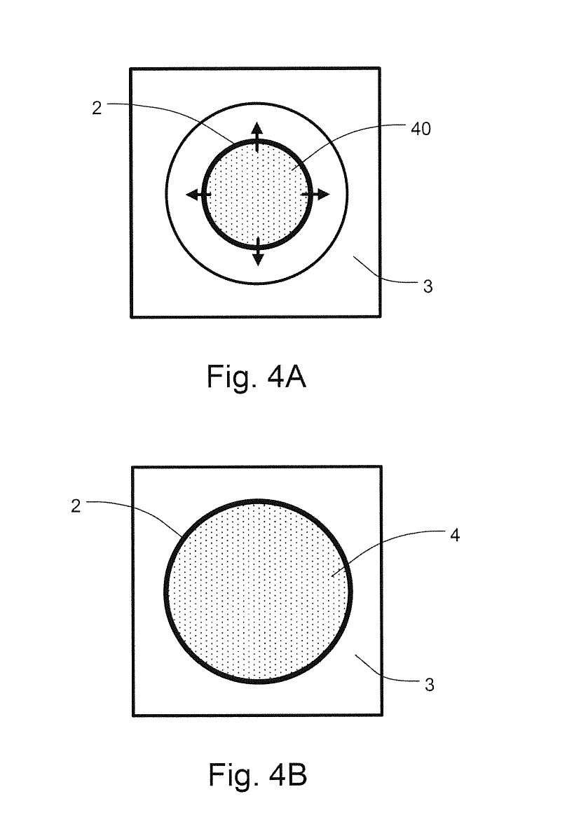

Refer to cross sections of the cavity shown in FIG. 4A and FIG. 4B, fillers 40 can expand quickly to fill the hollow air bag 2. The surface of the hollow air bag 2 is pushed to attach to an inner wall of the second mold 3 closely. After being molded, the filler 40 become core material 4 with solid structure and smooth surface in the hollow air bag 2. Although the core material 4 is located in and used for supporting the hollow air bag 2, the core material 4 is not adhered to the inner surface of the hollow air bag 2. Thus the difference in materials of the hollow air bag 2 and the core material 4 allow them to be separated from each other easily.

Then take the hollow air bag 2 with the core material 4 out. The surface of the hollow air bag 2 is covered by composite material 5 such as fiberglass fabric and carbon fiber fabric. The composite material 5 can be covered easily due to smooth surface of the hollow air bag 2 supported by the core material 4. The hollow air bag 2 covered by the composite material 5 and having the core material 4 therein is set into a third mold 6.

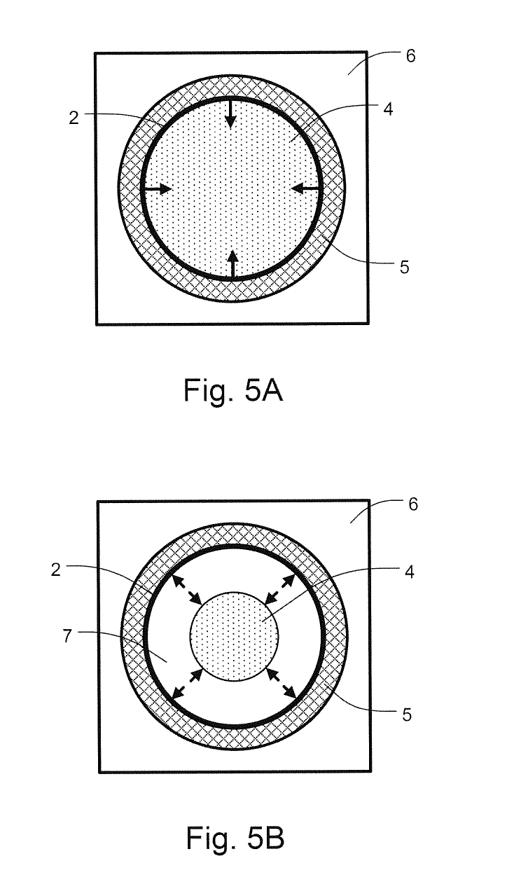

Next heat the third mold 6 up to 120° C.˜160° C. The core material 4 in the third mold 6 is also heated. At the same time, gas 7 is introduced into the hollow air bag 2 through the nozzle 21. Refer to FIG. 5A and FIG. 5B, the hollow air bag 2 is inflated like a balloon because that the hollow air bag 2 is made from elastic material with high toughness. The composite material 5 is pushed continuously by the gas 7 so that the composite material 5 is attached to a cavity wall of the third mold 6 closely and is molded well. Thus a structure preset by the third mold 6 is formed. As mentioned above, the core material 4 in the hollow air bag 2 is not adhered to the inner surface of the hollow air bag 2. Thus the gas 7 easily fills a space between the hollow air bag 2 and the core material 4 after being introduced. As to the core material 4, it is heated, melted and shrunk into small plastic strips or liquid that flowing out directly.

After quenching down, open the mold, and remove the molded product, the small plastic strips formed by the shrunk core material 4 can be cut and removed easily. The hollow air bag 2 is also removed. Thus a composite material product with smooth inner and outer walls and having high strength is obtained.

In summary, the method for molding composite materials according to the present invention is easy to operate. The products obtained have advantages of hardness, appropriate weight, and as a whole profile directly. The method is applied to products in different fields such as bicycle frames or irregular-shaped hollow products that use air bags during manufacturing processes. The irregular-shaped hollow products including wheel rims, rudders, boat paddles, etc, which can be produced by the same method mentioned above. Moreover, the hollow air bag is formed by elastic material so that the tube or bag is protected from breaking during foaming process of the filler inside due to tough appearance. The yield rate is also increased. The method achieves the requirements of the yield rate, strength, stiffness, and smooth appearance. There is no need to use labor for putty process. The energy consumed for heating and curing is lesser. Due to the advantages aforesaid and the operation of the procedures is convenient and simple. the method of the present invention has economic benefits and application prospects.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A method for molding composite material comprising the steps of:
injecting an elastic material into a first mold;
rotating or shaking the first mold or letting the first mold set, to form a hollow air bag in the first mold;
moving the hollow air bag into a second mold;
injecting a filler into the hollow air bag until the hollow air bag is filled and the filler forms a core material in the hollow air bag;
covering a composite material over a surface of the hollow air bag and then setting the hollow air bag in a third mold;
inflating the hollow air bag to expand the air bag and push the composite material to attach to an inner wall of the third mold, and heating the third mold until the composite material cured at the same time; and
removing the third mold, the core material, and the hollow air bag to get a molded composite material product.

2. The method as claimed in claim 1, wherein materials for the first mold, the second mold and the third mold are selected from the group consisting of metals, resin and gypsum.

3. The method as claimed in claim 1, wherein the elastic material is selected from the group consisting of silicone rubber, polyurethane resin, and emulsified rubber.

4. The method as claimed in claim 1, wherein the filler is selected from the group consisting of resin with foam powder, resin with expanding powder, polyurethane (PU), polyvinyl alcohol (PVA), wax and expanded polystyrene.

5. The method as claimed in claim 1, wherein the hollow air bag includes at least one nozzle.

6. The method as claimed in claim 1, wherein in the step of heating the third mold, heating temperature is ranging from 120° C. to 160° C. and the core material is shrunk into strips or melt into liquid.

7. The method as claimed in claim 1, wherein a thickness of the hollow air bag is ranging from 0.1 mm to 30 mm.

8. The method as claimed in claim 1, wherein a diameter of a cavity of the first mold is smaller than or equal to a diameter of a cavity of the second mold.

9. The method as claimed in claim 1, wherein a diameter of a cavity of the second mold is smaller than a diameter of a cavity of the third mold.

10. The method as claimed in claim 1, wherein the molded composite material product is a bicycle frame or an irregular-shaped hollow product.

11. The method as claimed in claim 10, wherein the irregular-shaped hollow product is a wheel rim, a rudder, or a boat paddle.
